(19) United States
(12) Patent Application Publication
(10) Pub. No.: US 2026/0082355 A1
(43) Pub. Date: Mar. 19, 2026

(54) DEVICE DISCOVERY AND POSITIONING

(71) Applicant: Nokia Technologies Oy, Espoo (FI)

(72) Inventors: Oana-Elena Barbu, Aalborg (DK); Benny Vejlgaard, Gistrup (DK); Johannes Harrebek, Aalborg (DK)

(21) Appl. No.: 19/109,482

(22) PCT Filed: Aug. 22, 2023
(86) PCT No.: PCT/EP2023/072976

§ 371 Date: Mar. 6, 2025

Related U.S. Application Data
(60) Provisional application No. 63/409,091, filed on Sep. 22, 2022.

(51) Int. Cl. H04W 64/00; H04W 8/00; H04W 24/10

(52) U.S. Cl. CPC H04W 64/00; H04W 8/005; H04W 24/10

(57) ABSTRACT

Systems, methods, apparatuses, and computer program products passive internet of things (IoT) discovery and positioning. A method may include obtaining, by a first device, a configuration to transmit a first signal for discovering a tag, and a configuration to select a transmitter device for transmitting a second signal for positioning the tag. The method may also include transmitting the first signal. The method may further include obtaining information on a reception of a tag response signal to the first signal. In addition, the method may include, based on the obtained information, selecting the transmitter device for transmitting the second signal. Further, the method may include selecting a reader device for a tag response signal to the second signal.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for discovery and positioning.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, and/or fifth generation (5G) radio access technology or NR access technology. 5G wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include obtaining, by a first device, a configuration to transmit a first signal for discovering a tag, and a configuration to select a transmitter device for transmitting a second signal for positioning the tag. The method may also include transmitting the first signal. The method may further include obtaining information on a reception of a tag response signal to the first signal, wherein the information comprises information on a reception of the tag response signal by at least one second device. In addition, the method may include, based on the obtained information, selecting the transmitter device for transmitting the second signal. Further, the method may include selecting at least one reader device for a tag response signal to the second signal.

Other example embodiments may be directed to an apparatus. The apparatus may include at least one processor and at least one memory including computer program code. The at least one memory and computer program code may also be configured to, with the at least one processor, cause the apparatus at least to obtain a configuration to transmit a first signal for discovering a tag, and a configuration to select a transmitter device for transmitting a second signal for positioning the tag. The apparatus may also be caused to transmit the first signal. The apparatus may further be caused to obtain information on a reception of a tag response signal to the first signal, wherein the information comprises information on a reception of the tag response signal by at least one second device. In addition, the apparatus may be caused to, based on the obtained information, select the transmitter device for transmitting the second signal. Further, the apparatus may be caused to select at least one reader device for a tag response signal to the second signal.

Other example embodiments may be directed to an apparatus. The apparatus may include means for obtaining a configuration to transmit a first signal for discovering a tag, and a configuration to select a transmitter device for transmitting a second signal for positioning the tag. The apparatus may also include means for transmitting the first signal. The apparatus may further include means for obtaining information on a reception of a tag response signal to the first signal, wherein the information comprises information on a reception of the tag response signal by at least one second device. In addition, the apparatus may include, based on the obtained information, means for selecting the transmitter device for transmitting the second signal. Further, the apparatus may include means for selecting at least one reader device for a tag response signal to the second signal.

In accordance with other example embodiments, a non-transitory computer readable medium may be encoded with instructions that may, when executed in hardware, perform a method. The method may include obtaining, by a first device, a configuration to transmit a first signal for discovering a tag, and a configuration to select a transmitter device for transmitting a second signal for positioning the tag. The method may also include transmitting the first signal. The method may further include obtaining information on a reception of a tag response signal to the first signal, wherein the information comprises information on a reception of the tag response signal by at least one second device. In addition, the method may include, based on the obtained information, selecting the transmitter device for transmitting the second signal. Further, the method may include selecting at least one reader device for a tag response signal to the second signal.

Other example embodiments may be directed to a computer program product that performs a method. The method may include obtaining, by a first device, a configuration to transmit a first signal for discovering a tag, and a configuration to select a transmitter device for transmitting a second signal for positioning the tag. The method may also include transmitting the first signal. The method may further include obtaining information on a reception of a tag response signal to the first signal, wherein the information comprises information on a reception of the tag response signal by at least one second device. In addition, the method may include, based on the obtained information, selecting the transmitter device for transmitting the second signal. Further, the method may include selecting at least one reader device for a tag response signal to the second signal.

Other example embodiments may be directed to an apparatus that may include circuitry configured to obtain a configuration to transmit a first signal for discovering a tag, and a configuration to select a transmitter device for transmitting a second signal for positioning the tag. The apparatus may also include circuitry configured to transmit the first signal. The apparatus may further include circuitry configured to obtain information on a reception of a tag response signal to the first signal, wherein the information comprises information on a reception of the tag response signal by at least one second device. In addition, the apparatus may include circuitry configured to, based on the obtained information, select the transmitter device for transmitting the second signal. Further, the apparatus may include circuitry configured to select at least one reader device for a tag response signal to the second signal.

Certain example embodiments may be directed to a method. The method may include receiving a configuration from a network element, wherein the configuration comprises settings to report a discovery measurement to a first device. The method may also include listening for a tag based on the configuration. The method may further include transmitting a measurement report to the first device based on the listening. According to certain example embodiments, the measurement report may include information on a tag power or a binary indicator associated with the tag.

Other example embodiments may be directed to an apparatus. The apparatus may include at least one processor and at least one memory including computer program code. The at least one memory and computer program code may be configured to, with the at least one processor, cause the apparatus at least to receive a configuration from a network element, wherein the configuration comprises settings to report a discovery measurement to a first device. The apparatus may also be caused to listen for a tag based on the configuration. The apparatus may further be caused to transmit a measurement report to the first device based on the listening. According to certain example embodiments, the measurement report may include information on a tag power or a binary indicator associated with the tag.

Other example embodiments may be directed to an apparatus. The apparatus may include means for receiving a configuration from a network element, wherein the configuration comprises settings to report a discovery measurement to a first device. The apparatus may also include means for listening for a tag based on the configuration. The apparatus may further include means for transmitting a measurement report to the first device based on the listening. According to certain example embodiments, the measurement report may include information on a tag power or a binary indicator associated with the tag.

In accordance with other example embodiments, a non-transitory computer readable medium may be encoded with instructions that may, when executed in hardware, perform a method. The method may include receiving a configuration from a network element, wherein the configuration comprises settings to report a discovery measurement to a first device. The method may also include listening for a tag based on the configuration. The method may further include transmitting a measurement report to the first device based on the listening. According to certain example embodiments, the measurement report may include information on a tag power or a binary indicator associated with the tag.

Other example embodiments may be directed to a computer program product that performs a method. The method may include receiving a configuration from a network element, wherein the configuration comprises settings to report a discovery measurement to a first device. The method may also include listening for a tag based on the configuration. The method may further include transmitting a measurement report to the first device based on the listening. According to certain example embodiments, the measurement report may include information on a tag power or a binary indicator associated with the tag.

Other example embodiments may be directed to an apparatus that may include circuitry configured to receive a configuration from a network element, wherein the configuration comprises settings to report a discovery measurement to a first device. The apparatus may also include circuitry configured to listen for a tag based on the configuration. The apparatus may further include circuitry configured to transmit a measurement report to the first device based on the listening. According to certain example embodiments, the measurement report may include information on a tag power or a binary indicator associated with the tag.

Certain example embodiments may be directed to a method. The method may include receiving a configuration from a network element, wherein the configuration comprises settings to report a discovery measurement to a first device. The method may also include triggering discovery of a tag by configuring a first device with a first configuration as a discovery activator to configure an activation signal. The method may also include triggering a localization session by configuring the first device with settings for selecting a localization activator and a localization reader. The method may further include configuring a second device and at least one other device as a set of discovery readers to report discovery measurements to the first device.

Other example embodiments may be directed to an apparatus. The apparatus may include at least one processor and at least one memory including computer program code. The at least one memory and computer program code may be configured to, with the at least one processor, cause the apparatus at least to trigger discovery of a tag by configuring a first device with a first configuration as a discovery activator to configure an activation signal. The apparatus may also be caused to trigger a localization session by configuring the first device with settings for selecting a localization activator and a localization reader. The apparatus may further be caused to configure a second device and at least one other device as a set of discovery readers to report discovery measurements to the first device.

Other example embodiments may be directed to an apparatus. The apparatus may include means for triggering discovery of a tag by configuring a first device with a first configuration as a discovery activator to configure an activation signal. The apparatus may also include means for triggering a localization session by configuring the first device with settings for selecting a localization activator and a localization reader. The apparatus may further include means for configuring a second device and at least one other device as a set of discovery readers to report discovery measurements to the first device.

In accordance with other example embodiments, a non-transitory computer readable medium may be encoded with instructions that may, when executed in hardware, perform a method. The method may include receiving a configuration from a network element, wherein the configuration comprises settings to report a discovery measurement to a first device. The method may also include triggering discovery of a tag by configuring a first device with a first configuration as a discovery activator to configure an activation signal. The method may also include triggering a localization session by configuring the first device with settings for selecting a localization activator and a localization reader. The method may further include configuring a second device and at least one other device as a set of discovery readers to report discovery measurements to the first device.

Other example embodiments may be directed to a computer program product that performs a method. The method may include receiving a configuration from a network element, wherein the configuration comprises settings to report a discovery measurement to a first device. The method may also include triggering discovery of a tag by configuring a first device with a first configuration as a discovery activator to configure an activation signal. The method may also include triggering a localization session by configuring the first device with settings for selecting a localization activator and a localization reader. The method may further include configuring a second device and at least one other device as a set of discovery readers to report discovery measurements to the first device.

Other example embodiments may be directed to an apparatus that may include circuitry configured to trigger discovery of a tag by configuring a first device with a first configuration as a discovery activator to configure an activation signal. The apparatus may also include circuitry configured to trigger a localization session by configuring the first device with settings for selecting a localization activator and a localization reader. The apparatus may further include circuitry configured to configure a second device and at least one other device as a set of discovery readers to report discovery measurements to the first device.

### BRIEF DESCRIPTION OF THE DRAWINGS

For proper understanding of example embodiments, reference should be made to the accompanying drawings, wherein:

FIG. 1 illustrates an example tag detection and localization procedure, according to certain example embodiments.

FIG. 2 illustrates an example signal diagram, according to certain example embodiments.

FIG. 3 illustrates an example flow diagram of a method, according to certain example embodiments.

FIG. 4 illustrates an example flow diagram of another method, according to certain example embodiments.

FIG. 5 illustrates an example flow diagram of a further method, according to certain example embodiments.

FIG. 6 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for discovery and positioning. For instance, certain example embodiments may be directed to return time indication on network (NW) switching for passive Internet of Things (IoT) discovery and positioning.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, “network” or other similar language throughout this specification may be used interchangeably. Additionally, the terms “tag localization” and “localization” may refer to locating the tag.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

The technical specifications of 3^{rd} Generation Partnership Project (3GPP) specifies narrowband (NB) IoT/enhanced machine-type communication (eMTC) and NR reduced capability (RedCap) to satisfy requirements on low cost and low power devices for wide area IoT communication. These IoT devices may consume tens or hundreds of milliwatts of power when transceiving, while the cost of doing so remains low. However, to achieve the internet of everything, IoT devices with ten or even a hundred times lower cost and power consumption may be needed, especially for a large number of applications that may require battery-free devices.

In recent years, the number of IoT connections has been growing rapidly. With more and more “things” expected to be interconnected for improving production efficiency and increasing comforts of life, there may be demands for further reduction of size, cost, and power consumption for IoT devices. For instance, regular replacements of batteries for IoT devices may be impractical due to the significant consumption of materials and manpower. It has also become a trend to use energy harvested from environments to power IoT devices for self-sustainable communications. This may be especially true in applications with a large number of devices (e.g., ID tags and sensors).

An issue with existing 3GPP technologies for certain target use cases may be the capability of cooperating with energy harvesting considering limited device size. Cellular devices may consume tens or hundreds of milliwatts of power for transceiving and processing. Taking the NB-IoT module as an example, the typical current consumption for receive processing may be about 60 mA with a supply voltage higher than 3.1 V, while 70 may be needed for transmission processing at 0 dBm transmit power. The output power provided by a typical energy harvester may be below 1 milliwatt, considering the small size of a few square centimeters for practical devices. Since the available power is significantly less than the consumed power, it may be impractical for power cellular devices directly by energy harvesting.

A possible solution to the issues described above may be to integrate energy harvesting with rechargeable batteries or supercapacitors. However, some problems may still exist. For instance, both the rechargeable battery and the supercapacitor may suffer from a shortened lifespan since it may be difficult to provide a constant charging current or voltage by energy harvesting, while longtime continuous charging may be needed due to the small output power from the energy harvester. An inconsistent charging current and long-term continuous charging may both be harmful to battery life. In particular, for a supercapacitor, its lifetime may be significantly reduced in high temperature environments (e.g., less than 3 years at 50° C.).

Another problem may be due to device size, which can be significantly increased. Since a small size button battery may provide current of a few tens of milliamps, a battery with a much larger size (e.g., AA battery) may be used to power cellular devices, whose size can be even larger than the module itself. To store energy for a proper duration of working (e.g., one second), the required capacitance of a supercapacitor may be at the level of a hundred mill-farads. Additionally, the size of such supercapacitors may be larger than an NB-IoT module.

A further problem may be that both rechargeable batteries and supercapacitors may be more expensive than the module itself. Even purchased in large quantities, the cost of a suitable battery or supercapacitor may reach one or a few dollars, which nearly doubles the cost of the device itself.

In view of the above, there are certain non-3GPP technologies that may help resolve such problems. For instance, radio-frequency identification (RFID) technology may support battery-less tags (e.g., devices). The power consumption of commercial passive RFID tags may be as low as 1 microwatt. The key techniques enabling such low power consumption may include envelope detection for downlink (DL) data reception, and backscatter communication for uplink (UL) data transmission. RFID may be designed for short-range communications whose typical effective range may be less than 10 meters. As the air interface of RFID has essentially remained unchanged since 2005, the too-simple transmission scheme has become an obstacle of improving its link budget and capability of supporting a scalable network.

3GPP provides certain passive IoT solutions in 5G NR. However, from certain use cases and requirements, different companies have presented vast diverging options on both use cases and requirements for NR-based IoT. Thus, baseline solutions for NR-based passive IoT may still need to be developed. To support and integrate passive IoT in a 5G NR network infrastructure, the network may need to identify a coarse location (i.e., an approximate location) of the tag since there may be no active elements on the tag, and therefore no means for the tag to make itself visible or heard.

Discovering a passive IoT device may be challenging due to the inherent nature of the passive radio. In particular, the passive radio may not have a power source, may be mobile, and may hear other radios in its own proximity (e.g., most often within a 5-10 m radius). Furthermore, the mobility and operation of the passive IoT device (i.e., how much data has collected) may be transparent to the NR NW. Due to such limitations, the NR NW may not apply typical NR UE paging operations, and alternatives may need to be defined.

In some cases, the NR NW may discover the tag if the tag hears an activation signal loud enough so that the tag can charge sufficiently, and so that the tag can generate an “I am here” response which is loud enough to be heard by another nearby NW element (e.g., a gNB, roadside unit (RSU), UE, etc.). In view of the above, certain example embodiments may address the various problems exhibited by passive IoT devices in 5G NR networks including, for example, problems associated with time and spectral-efficient discovery and positioning of such passive IoT devices.

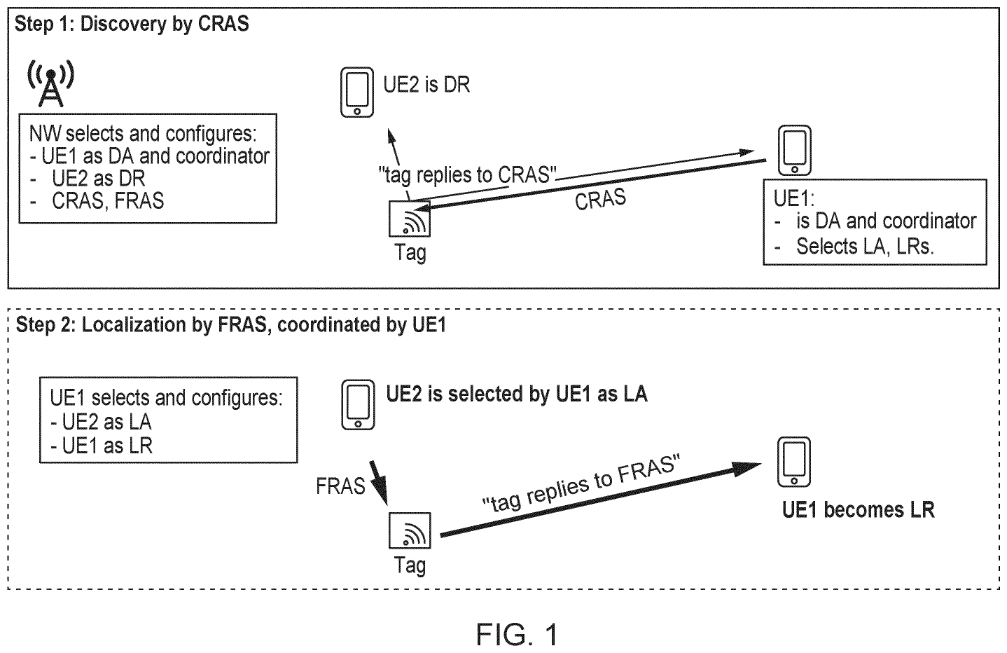

FIG. 1 illustrates an example tag detection and localization procedure, according to certain example embodiments. As illustrated in FIG. 1, certain example embodiments may provide a framework for resource optimization of the discovery and the subsequent localization of a passive device such as, for example, a tag. For instance, the framework of certain example embodiments may include a step for tag discovery that may be carried out by a NW-selected activator such as, for example, a discovery-activator (DA). As illustrated in FIG. 1, the NW may select and configure UE1 as the DA and coordinator, and UE2 as a discovery reader (DR). The DA may trigger the tag discovery using a small bandwidth, coarse resolution, short activation signal (CRAS). DA may sometimes be referred to as a transmitter device for transmitting first signal (or CRAS) for discovery of the tag or tags. Additionally, the tag discovery may be performed by a set of DRs. For example, the set of DRs may comprise a plurality of DRs. For example, the network, such as LMF, may select the DRs. DR may sometimes be referred to as a reader or reception device for receiving tag response from a tag or tags to be discovered, wherein the tag response is transmitted by the tag or tags based on or in response to the first signal. In some example embodiments, the DA may also select and configure the activator for subsequent tag localization (i.e., localization activator (LA)), and select and configure one or more localization readers (LRs). LA may sometimes be referred to as a transmitter device for transmitting a second signal (FRAS) for localization or positioning of the tag or tags. LR may sometimes be referred to as a reception or reader device for receiving for receiving tag response from a tag or tags to be positioned, wherein the tag response is transmitted by the tag or tags based on or in response to the second signal. Tag response signal to the first signal may also be referred to as first tag response signal and tag response signal to the second signal may also be referred to as a second tag response signal.

As illustrated in FIG. 1, in certain example embodiments, the framework may also include a step involving tag localization. According to some example embodiments, the tag localization may be coordinated by the initial DA, and may be triggered by the selected LA via the LA's transmission of a larger BW, finer resolution, and/or longer duration activation signal (FRAS). Further, the tag localization may be carried out by the LA and LRs, where the latter may collect positioning measurements on a tag reply to the FRAS. Thus, as described above, tag discovery may reduce associated resource utilization when little or no information about the tag location is known, while tag localization may enable a targeted activation by the LA to enable the tag to charge and respond loud enough to be read by multiple readers.

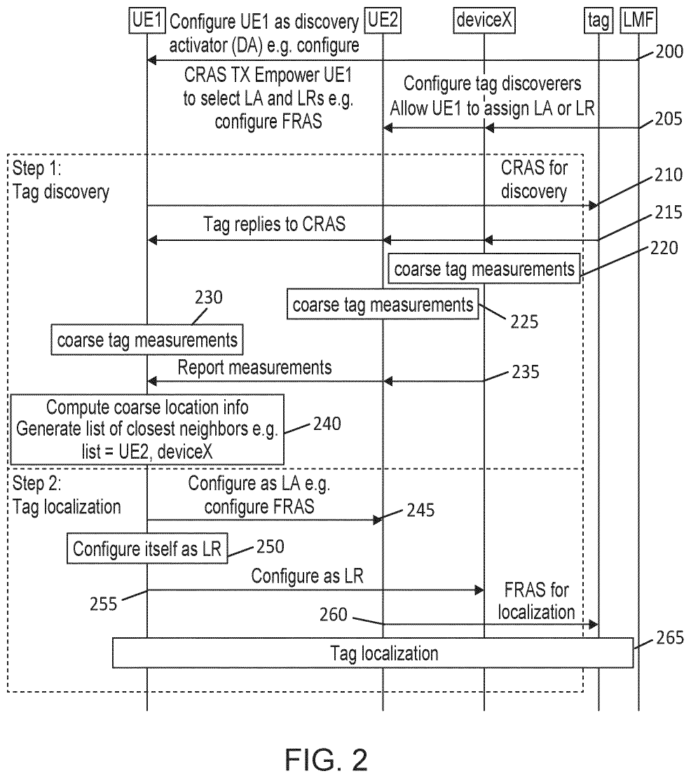

FIG. 2 illustrates an example signal diagram, according to certain example embodiments. At 200, the LMF/gNB may trigger a tag discovery and localization session via a given UE (UE1). As illustrated in FIG. 2, UE1 may be selected by the LMF/gNB as the DA. In some example embodiments, UE1 may be selected based on past knowledge of the tag location or at random, if no such knowledge is available. According to certain example embodiments, and as discussed in more detail below, UE1 may be empowered by the LMF/gNB to select an LA and the LRs for tag localization.

At 205, the LMF/gNB may configure a set of DRs such as, for example, UE2 and other devices (i.e., deviceX) that listen for a reply from the tag. The LMF/gNB may also configure UE1 to be able to assign an LA or LR. In some example embodiments, the LMF/gNB may configure DR to report discovery measurements to UE1, and allow UE1 to configure them with LA or LR roles in the tag localization step.

As illustrated in FIG. 2, once UE1 and UE2 have been configured, tag discovery may be initiated or carried by the DA (e.g., UE1). In particular, at 210, UE1 may broadcast a CRAS, and the CRAS may be a low BW signal that activates the tag to reply, and may also charge the tag, depending on the tag architecture. In certain example embodiments, the CRAS may be transmitted on a dedicated carrier Fcras, with BW Bcras, and may have a known short duration Teras selected and configured by the NW. In some example embodiments, a reduced power CRAS may be sufficient for TAG discovery by one or a few DRs. As such, DA UE1 may transmit CRAS at max power, reduced power, or re-transmit CRAS at increasing power until DRs start reporting detection.

At 215, the DA UE1 and the selected DRs (e.g., UE2 and deviceX) may listen for a potential tag reply. At 220, 225, and 230, the DRs that hear the tag reply may report the reply to a coordinating entity (e.g., UE1) in the form of discovery measurements. In certain example embodiments, the discovery measurements may include an RX tag power value and/or a binary indicator associated with each tag that the DRs hear. For instance, the binary indicator associated with each tag may be represented as tag(IDx)=1, which may mean that the IDx tag has been detected.

At 235, UE1 may receive the measurement reports from the DRs. At 240, UE1 may use the measurement reports to determine coarse location information (CLI) as the centroid of all the listening devices (when their location is known). Alternatively, in other example embodiments, UE1 may use the measurement reports to generate a list of neighbor devices that are deemed close to the tag. For instance, neighbor devices may be within a range R from the tag, where R may be 5, 10, or 30 m. In some example embodiments, the list may be arranged in increasing order of distance between the device and the tag. For instance, a list={UE2, UE1, deviceX} may indicate that UE2 is the closest to the tag, while deviceX is the furthest away. In other example embodiments, UE1 may use the CLI derived above to select the LA and one or more LRs. For example, UE2 may be selected as the LA, and UE1 and deviceX may be selected as LRs.

As illustrated in FIG. 2, a tag localization step may be provided. Under this step, the location of the tag may be determined. This may also be referred to as determining position of the tag. Hence, tag localization step may also be referred to as tag positioning step. At 245, in the tag localization step, UE1 may configure UE2 as the LA. That is, the UE1 may indicate to UE2 that UE2 has been selected as transmitter device for transmitting a localization activation signal. As an LA, UE2 may send the localization activation signal. The localization activation signal (sometimes referred to as a second signal or FRAS) may be characterized by a larger BW, and/or larger duration compared to the discovery activation signal (sometimes referred to as a first signal or CRAS). In certain example embodiments, the configuration may include the parameters (e.g., carrier, bandwidth, time) of the FRAS for each target tag. According to certain example embodiments, the FRAS for each target tag may include Ffras, Bfras, Tfras, etc., where Bfras>Bcras, and Tfras>Teras. Ffras refers to carrier frequency of the FRAS signal, Fcras refers to carrier frequency of the CRAS signal, Bfras refers to bandwidth of the FRAS signal, Bcras refers to bandwidth of the CRAS signal, Tfras refers to duration of the FRAS signal, and Tfras refers to duration of the CRAS signal. For instance, duration of a signal may be indicated in radio symbols, such as OFDM (Orthogonal frequency-division multiplexing) symbols.

At 250, UE1 may configure communication devices as LRs. For instance, in some example embodiments, UE1 may configure itself as an LR. Further, at 255, UE1 may configure deviceX as an LR. In certain example embodiments, the LR may receive the tag reply and measure the reply to obtain position measurements used to locate the tag. According to certain example embodiments, the configuration may include parameters of the tag reply (needed to detect the tag signal). For instance, the parameters of the tag reply may include a tag-specific waveform (e.g., carrier, BW, code, etc.), and the parameters may include positioning metrics that the readers may compute (e.g., tag time of arrival (TOA), angle of arrival (AOA), received power, etc.).

At 260, UE2 may send the localization activation signal FRAS to the tag, and at 265, the readers may measure the tag and report the measurements to UE1, or directly to the serving gNB of the readers. In some example embodiments, positioning measurements may be reported to the entity that is in charge of computing the final location of the tag. That entity may be the one that initiated the process of tag detection and localization (e.g., UE1), or another entity designated to do so (i.e., another reader or activator). Additionally, in some example embodiments, the reported measurements may be used to locate the tag.

In other example embodiments, the DA may select an LA, and may empower the LA to select its own LRs. According to some example embodiments, the LA may then select as LRs, a set of neighbor UEs with which the LA has previously established a sidelink (SL). In other example embodiments, the DA may select an LA and a first set of LRs, and may also empower the LA to select a second set of LRs. The DA may then configure the first set while the LA configures (as instructed by the DA) the second set of LRs.

According to certain example embodiments, the CRAS may correspond to a discovery activation signal that activates the tag to reply. The CRAS may be a type of waveform such as, for example, a single carrier or multicarrier wave where the waveform may be unique to the ID(s) of the tag that it activates. In other example embodiments, CRAS may be a carrier frequency Fcras, which the tag is listening to. According to some example embodiments, Fcras may be selected by the NW in connection to the type of the tag for which the NW requires localization. In other example embodiments, CRAS may be a small BW Bcras such as, for example, Bcras=5 MHz. With a small BW, it may be possible to optimize the resource efficiency. In further example embodiments, CRAS may be described as a duration Teras such as, for example, Teras=1 OFDM symbol, where the duration is selected in relation to a selected transmit power Pcras (i.e., for a single CRAS transmission) so that the average power over the total transmit time is less than a preset threshold (e.g., set by the UE itself, or by the NW).

In certain example embodiments, CRAS may be sent by a DA, and may not be heard by the discovery readers. In some example embodiments, when the tag reply to CRAS is on the same resources, DA-to-tag interference may arise. To mitigate the effect, the NW may also transfer a CRAS configuration to each DR for the DR to be able to cancel the CRAS effect from the RX signal prior to attempting the tag discovery.

According to certain example embodiments, FRAS may correspond to a localization activation signal that may be a type of waveform. For instance, the waveform may be a single carrier or a multicarrier wave where the waveform may be unique to the ID(s) of the tag that FRAS needs to activate. In other example embodiments, FRAS may correspond to a carrier frequency Ffras that the tag is listening to. In certain example embodiments, Ffras may be selected by the NW in connection with the type of the tag for which the NW requires localization. In certain example embodiments, a large BW Bfras>Bcras. For instance, Bcras=20 MHz to enable a finer sampling resolution of the tag reply to FRAS. In other example embodiments, a larger duration Tfras>Tcras may be needed. For example, Tfras=8 OFDM symbols to ensure that the tag charges sufficiently, and that the tag reply is heard by the selected LRs.

In certain example embodiments, FRAS may be sent by the LA, and may or may not be heard by the LR. When the tag reply to FRAS is on the same resources, LA-to-tag interference may arise. Thus, to mitigate this effect, UE1 may also transfer FRAS configuration to each LR for the LR to be able to cancel the FRAS effect from the RX signal prior to attempting the tag positioning measurements.

According to certain example embodiments, the configuration of the DA and the DR by the NW may be realized via the serving gNB. For instance, this may be accomplished by a downlink physical downlink shared channel (DL PDSCH) or a DL small data transmission (SDT) (for radio resource control (RRC) INACTIVE). Here, the payload may include at least the list of tags that should be discovered, the CRAS configuration, and a total listening duration Deras during which the DR collects discovery measurements of the tag. In some example embodiments, the configuration of the DA and the DR by the NW may be realized via the LMF via LTE positioning protocol (LPP) assistance data (sent between the LMF and the UE) where such assistance data includes the same payload as that of the gNB described above.

In certain example embodiments, the configuration of the LA and LRs may be performed by the DA, and may be realized via SL physical SL shared channel (PSSCH) sent by the DA. In other example embodiments, the configuration of the LA and LRs by the DA may be realized via DL PDSCH sent by the serving gNBs. For instance, the DL PDSCH may be sent by the serving gNBs after the DA has sent a list of LA and LRs to the gNB. In further example embodiments, the configuration of the LA and LRs by the DA may be realized via LPP by the LMF after the Da has sent a list of LA and LRs to the LMF. Additionally, in certain example embodiments, the payload of the above data channels (e.g., SL PSSCH, DL PDSCH, and LPP) may include at least the list of tags that should be positioned, the FRAS configuration, and a total listening duration Dfras during which the LR collects positioning measurements of the tag.

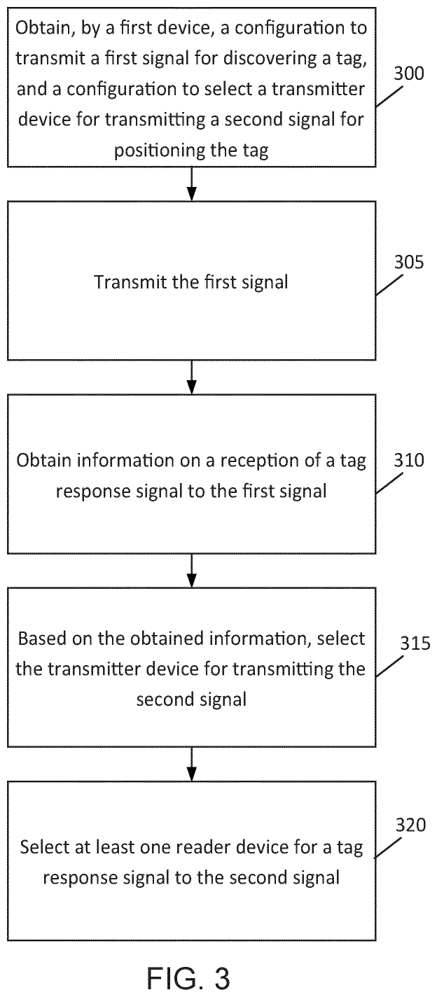

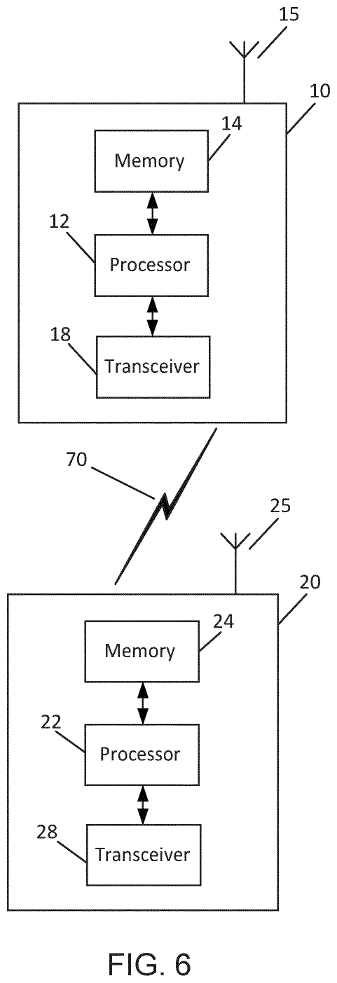

FIG. 3 illustrates an example flow diagram of a method, according to certain example embodiments. In an example embodiment, the method of FIG. 3 may be performed by a network entity, or a group of multiple network elements in a 3GPP system, such as LTE or 5G-NR. For instance, in an example embodiment, the method of FIG. 3 may be performed by a UE similar to one of apparatuses 10 or 20 illustrated in FIG. 6.

According to certain example embodiments, the method of FIG. 3 may include, at 300, obtaining, by a first device, a configuration to transmit a first signal for discovering a tag, and a configuration to select a transmitter device for transmitting a second signal for positioning the tag. The method may also include, at 305, transmitting the first signal. The method may further include, at 310, obtaining information on a reception of a tag response signal to the first signal, wherein the information comprises information on a reception of the tag response signal by at least one second device. In addition, the method may include, at 315, based on the obtained information, selecting the transmitter device for transmitting the second signal. Further, the method may include, at 320, selecting at least one reader device for a tag response signal to the second signal. In some examples, a reader device may be referred to as a reception device. Selecting (e.g. operation 315 and/or operation 320) as used herein may comprise transmitting, by the first device, one or more messages or indication to the selected device, wherein the one or more messages or indication indicates to the selected device that it has been selected as a transmitter device or as a reader device. If first device selects itself as a transmitter device or as a reader device, such transmission of a message via radio interface may not be needed, and the first device may simply select itself for the determined role.

According to certain example embodiments, the obtaining information on the reception of the tag response signal to the first signal may include receiving, from the at least one second device, information on a reception, by the at least one second device, of the tag response signal. According to some example embodiments, the obtaining information on the reception of the tag response signal to the first signal may include receiving, from the tag, the tag response signal. According to further example embodiments, the method may also include obtaining a configuration to select at least one reader device for receiving a response from the tag to the second signal, and selecting the at least one reader device amongst the first device and the at least one second device.

In certain example embodiments, selection of one of the at least one second device as the transmitter device may include selecting one of the at least one second device as the transmitter device. In other example embodiments, the method may also include transmitting, to the selected second device, information indicating the selection and a configuration of the second signal. In some example embodiments, selecting the at least one reader device amongst the first device and the at least one second device may include selecting the first device as one of the at least one reader device. In other example embodiments, the method may further include initiating reception of a tag response signal from the tag to the second signal. In other example embodiments, the method may also include obtaining information on a reception of a tag response signal to the second signal. In further example embodiments, the method may include at least one of the following: transmitting the information to a network element for positioning of the tag, or determining a position of the tag based on the obtained information.

According to certain example embodiments, the information on the reception of the tag response signal to the second signal may be at least partially obtained by receiving information on reception of the tag response signal to the second signal from one or more second devices. According to some example embodiments, the first signal may be configured to be transmitted with at least one of the following: smaller bandwidth, coarser resolution, shorter time period, or lower power compared with the second signal. According to other example embodiments, the selecting the transmitter device may be based on at least one parameter indicative of a distance between the tag and the transmitter device. According to further example embodiments, the at least one parameter may be obtained based on the information on the reception of the tag response signal to the first signal.

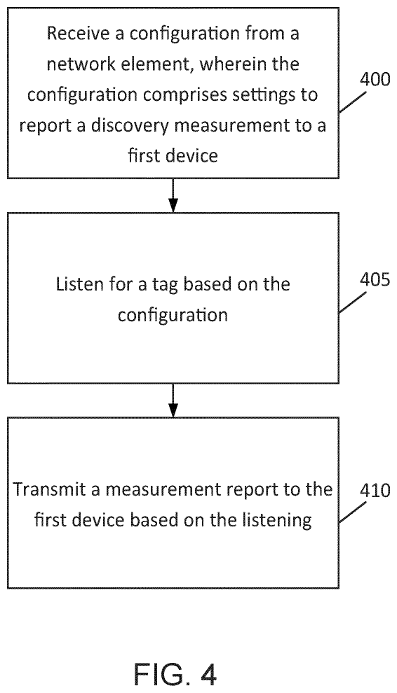

FIG. 4 illustrates an example flow diagram of a method, according to certain example embodiments. In an example embodiment, the method of FIG. 4 may be performed by a network entity, or a group of multiple network elements in a 3GPP system, such as LTE or 5G-NR. For instance, in an example embodiment, the method of FIG. 4 may be performed by a UE similar to one of apparatuses 10 or 20 illustrated in FIG. 6.

According to certain example embodiments, the method of FIG. 3 may include, at 400, receiving a configuration from a network element, wherein the configuration comprises settings to report a discovery measurement to a first device. At 405, the method may also include listening for a tag based on the configuration. At 410, the method may include transmitting a measurement report to the first device based on the listening. In certain example embodiments, the measurement report may include information on a tag power or a binary indicator associated with the tag.

According to certain example embodiments, the method may also include receiving, from the first device, configuration settings for operating as a localization activator. According to some example embodiments, the configuration settings for operating as the localization activator may include parameters of a fine resolution activation signal for each target tag.

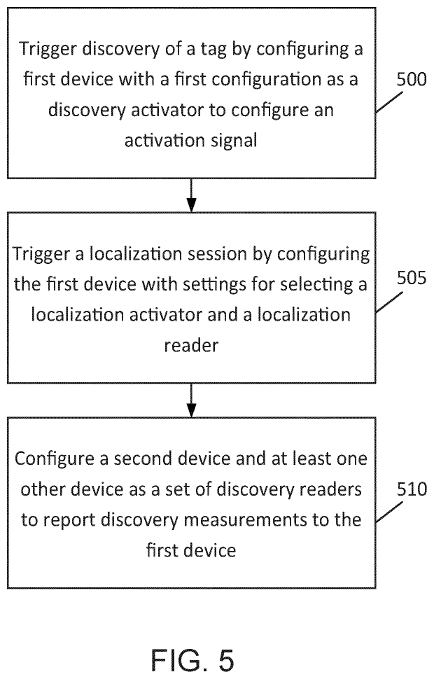

FIG. 5 illustrates an example of a flow diagram of another method, according to certain example embodiments. In an example embodiment, the method of FIG. 5 may be performed by a network entity, or a group of multiple network elements in a 3GPP system, such as LTE or 5G-NR. For instance, in an example embodiment, the method of FIG. 5 may be performed by an LMF, a gNB, network, cell, or any other device similar to one of apparatuses 10 or 20 illustrated in FIG. 6.

According to certain example embodiments, the method of FIG. 5 may include, at 500, triggering discovery of a tag by configuring a first device with a first configuration as a discovery activator to configure an activation signal. At 505, the method may further include, triggering a localization session by configuring the first device with settings for selecting a localization activator and a localization reader. At 510, the method may also include configuring a second device and at least one other device as a set of discovery readers to report discovery measurements to the first device.

According to certain example embodiments, configuring the second device may include configuring the discovery readers to report the discovery measurements to the first device. According to other example embodiments, the discovery measurements may include a tag power level measurement, or a binary indicator associated with the tag.

FIG. 6 illustrates a set of apparatuses 10 and 20 according to certain example embodiments. In certain example embodiments, the apparatus 10 may be an element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 6.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 6.

As illustrated in the example of FIG. 6, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 6, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-5.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-5.

In some example embodiments, apparatus 10 may also include or be coupled to one or more antennas 15 for receiving a downlink signal and for transmitting via an UL from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to obtain a configuration to transmit a first signal for discovering a tag, and a configuration to select a transmitter device for transmitting a second signal for positioning the tag. Apparatus 10 may also be controlled by memory 14 and processor 12 to transmit the first signal. Apparatus 10 may further be controlled by memory 14 and processor 12 to obtain information on a reception of a tag response signal to the first signal, wherein the information comprises information on a reception of the tag response signal by at least one second device. In addition, apparatus 10 may be controlled by memory 14 and processor 12 to, based on the obtained information, select the transmitter device for transmitting the second signal. Further, apparatus 10 may be controlled by memory 14 and processor 12 to select at least one reader device for a tag response signal to the second signal.

In other example embodiments, apparatus 10 may be controlled by memory 14 and processor 12 to receive a configuration from a network element, wherein the configuration comprises settings to report a discovery measurement to a first device. Apparatus 10 may also be controlled by memory 14 and processor 12 to listen for a tag based on the configuration. Apparatus 10 may further be controlled by memory 14 and processor 12 to transmit a measurement report to the first device based on the listening. In certain example embodiments, the measurement report may include information on a tag power or a binary indicator associated with the tag.

As illustrated in the example of FIG. 6, apparatus 20 may be a network, core network element, or element in a communications network or associated with such a network, such as an LMF or a gNB. It should be noted that one of ordinary skill in the art would understand that apparatus 20 may include components or features not shown in FIG. 6.

As illustrated in the example of FIG. 6, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 6, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1, 2, and 5.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 3-5.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an UL).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to trigger discovery of a tag by configuring a first device with a first configuration as a discovery activator to configure an activation signal. Apparatus 20 may also be controlled by memory 24 and processor 22 to trigger a localization session by configuring the first device with settings for selecting a localization activator and a localization reader. Apparatus 20 may further be controlled by memory 24 and processor 22 to configure a second device and at least one other device as a set of discovery readers to report discovery measurements to the first device.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for obtaining a configuration to transmit a first signal for discovering a tag, and a configuration to select a transmitter device for transmitting a second signal for positioning the tag. The apparatus may also include means for transmitting the first signal. The apparatus may further include means for obtaining information on a reception of a tag response signal to the first signal, wherein the information comprises information on a reception of the tag response signal by at least one second device. In addition, the apparatus may include, based on the obtained information, means for selecting the transmitter device for transmitting the second signal. Further, the apparatus may include means for selecting at least one reader device for a tag response signal to the second signal.

Certain example embodiments may also be directed to an apparatus that includes means for receiving a configuration from a network element, wherein the configuration comprises settings to report a discovery measurement to a first device. The apparatus may also include means for listening for a tag based on the configuration. The apparatus may further include means for transmitting a measurement report to the first device based on the listening. According to certain example embodiments, the measurement report may include information on a tag power or a binary indicator associated with the tag.

Certain example embodiments may also be directed to an apparatus that includes means for triggering discovery of a tag by configuring a first device with a first configuration as a discovery activator to configure an activation signal. The apparatus may also include means for triggering a localization session by configuring the first device with settings for selecting a localization activator and a localization reader. The apparatus may further include means for configuring a second device and at least one other device as a set of discovery readers to report discovery measurements to the first device.

Certain example embodiments described herein provide several technical improvements, enhancements, and /r advantages. For instance, in some example embodiments, it may be possible to optimize tag discovery time, optimize tag positioning estimation by tag activator proximity optimization, optimize spectral resource usage, and minimize NW complexity and configurations.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

3GPP 3rd Generation Partnership Project
5G 5th Generation
5GCN 5G Core Network
5GS 5G System
AOA Angle of Arrival
BS Base Station
CPE Customer Premises Equipment
CRAS Coarse Resolution Activation Signal
DA Discovery Activator
DL Downlink
DR Discovery Reader
eNB Enhanced Node B
E-UTRAN Evolved UTRAN
FRAS Fine Resolution Activation Signal
gNB 5G or Next Generation NodeB
LA Localization Activator
LR Localization Reader
LTE Long Term Evolution
NR New Radio
NW Network
Rx Receive TOATime of Arrival
Tx Transmit
UE User Equipment
UL Uplink

1-17. (canceled)

18. An apparatus, comprising:
at least one processor; and
at least one memory storing instructions that, when executed by the at least one processor, cause the apparatus at least to:
obtain a configuration to transmit a first signal for discovering a tag, and a configuration to select a transmitter device for transmitting a second signal for positioning the tag;
transmit the first signal;
obtain information on a reception of a tag response signal to the first signal, wherein the information comprises information on a reception of the tag response signal by at least one other device;
based on the obtained information, select the transmitter device for transmitting the second signal; and
select at least one reader device for a tag response signal to the second signal.

19. The apparatus according to claim 18, wherein the at least one memory further stores instructions that, when executed by the at least one processor, cause the apparatus at least to:
receive, from the at least one other device, information on a reception, by the at least one other device, of the tag response signal.

20. The apparatus according to claim 18, wherein the at least one memory further stores instructions that, when executed by the at least one processor, cause the apparatus at least to:
receive, from the tag, the tag response signal.

21. The apparatus according to claim 18, wherein the at least one memory further stores instructions that, when executed by the at least one processor, cause the apparatus at least to:
obtain a configuration to select at least one reader device for receiving a response from the tag to the second signal; and
select the at least one reader device amongst the apparatus and the at least one other device.

22. The apparatus according to claim 21, wherein when one of the at least one other device is selected as the transmitter device, the at least one memory further stores instructions that, when executed by the at least one processor, cause the apparatus at least to:
transmit, to the selected at least one other device, information indicating the selection and a configuration of the second signal.

23. The apparatus according to claim 18, wherein when the apparatus is selected as one of the at least one reader device, the at least one memory further stores instructions that, when executed by the at least one processor, cause the apparatus at least to:
initiate reception of a response signal from the tag to the second signal.

24. The apparatus according to claim 18, wherein the at least one memory further stores instructions that, when executed by the at least one processor, cause the apparatus at least to:
obtain information on a reception of a tag response signal to the second signal; and
at least one of the following: transmit the information to a network element for positioning of the tag, or determine position of the tag based on the obtained information.

25. The apparatus according to claim 24, wherein the information on the reception of the tag response signal to the second signal is at least partially obtained by receiving information on reception of the tag response signal to the second signal from one or more other devices.

26. The apparatus according to claim 18, wherein the first signal is configured to be transmitted with at least one of the following: smaller bandwidth, coarser resolution, shorter time period, or lower power compared with the second signal.

27. The apparatus according to claim 18, wherein the selection of the transmitter device is based on at least one parameter indicative of a distance between the tag and the transmitter device.

28. The apparatus according to claim 27, wherein the at least one parameter is obtained based on the information on the reception of the tag response signal to the first signal.

29. An apparatus, comprising:
at least one processor; and
at least one memory storing instructions that, when executed by the at least one processor, cause the apparatus at least to:
receive a configuration from a network element, wherein the configuration comprises settings to report a discovery measurement to a first device;
listen for a tag based on the configuration; and
transmit a measurement report to the first device based on the listening, wherein the measurement report comprises information on a tag power or a binary indicator associated with the tag.

30. The apparatus according to claim 29, wherein the at least one memory further stores instructions that, when executed by the at least one processor, cause the apparatus at least to:
receive, from the first device, configuration settings for operating as a localization activator.

31. The apparatus according to claim 30, wherein the configuration settings for operating as the localization activator comprises parameters of a fine resolution activation signal for each target tag.

32. An apparatus, comprising:
at least one processor; and
at least one memory storing instructions that, when executed by the at least one processor, cause the apparatus at least to:
trigger discovery of a tag by configuring a first device with a first configuration as a discovery activator to configure an activation signal;
trigger a localization session by configuring the first device with settings for selecting a localization activator and a localization reader; and
configure a second device and at least one other device as a set of discovery readers to report discovery measurements to the first device.

33. The apparatus according to claim 32, wherein configuring the second device comprises configuring the discovery readers to report the discovery measurements to the first device.

34. The apparatus according to claim 32, wherein the discovery measurements comprises:
a tag power level measurement, or a binary indicator associated with the tag.

35-53. (canceled)
